(19) United States
(12) Patent Application Publication
(10) Pub. No.: US 2004/0262815 A1
(43) Pub. Date: Dec. 30, 2004

(54) Method for manufacturing microstructure using light hardenable material

(76) Inventors: Chia-Lung Kuo, Touliu City (TW); Shi-Chang Tzeng, Touliu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/603,829

(22) Filed: Jun. 26, 2003

(51) Int. Cl. B29C 35/08

(52) U.S. Cl. 264/496; 264/81

(57) ABSTRACT

It relates to a method for manufacturing microstructure using light hardenable material. It mainly includes the steps of (1) preparing step, (2) sputtering step, (3) UV light exposing step, and (4) mold removing step. By utilizing the sputtering principle and the UV light or the like to solidify a light hardenable material and then to form a microstructure with many small through holes or close ended recesses. It not only can manufacture the microstructure plate used on the ink jet printer, but also can apply to the microlens array, microlens, biotechnological chips, tiny structures of a battery, or other microstructure in the nano-technology industry.

### BACKGROUND OF THE INVENTION

1. Field of the Invention

The present invention relates to a method for manufacturing microstructure using light hardenable material. Particularly, it relates to a method for manufacturing microstructure using light hardenable material having at least micro-sized holes, recesses or special profiles that can apply to ink jet printer, microlens, biotechnological chips, tiny structure in the battery and related micro- or nano-technology devices.

2. Related Background Art

Referring to FIGS. 1 & 2, the ink jet thin plate 60 used in the ink jet printer has a length of 7 mm, a width of 4 mm and a thickness (T) of 50 μm (micrometer). There are lots of through holes 61 on this ink jet thin plate 60. The diameter (d) of the through holes 61 is approximately 100 μm. The distance (D) between two adjacent through holes 61 is about 100 to 200 μm. Because the diameter (d) of the through hole 61 is too small, it cannot be formed by the traditional drilling technique. However, except the traditional drilling technique, there are two existing methods to form such small through hole 61 described as follows.

The first conventional method is laser beam cutting method. The disadvantage of this method is that the inner surface of the cutting hole is quite rough. If this method is applied to the ink jet printer, the rough surface will significantly increase the dragging force at the interface between the inner surface and the flowing ink. Therefore, The rough inner surface will increase the flowing resistance of the ink. Even worse, it is possible to block some of the through holes 61. In addition, because the laser beam only can drill a straight through hole 61, it is impossible to drill a through hole 61 having a curved or conical inner surface. Thus, it is impossible to manufacture a microstructure that having through holes with curved shape or special profile.

The second conventional method is to use the cupper electroforming method. However, such method is quite complicated, time consuming and hard to precisely control.

Therefore, it is necessary to develop a new manufacturing method to overcome the disadvantages of the above-mentioned two conventional methods.

### SUMMARY OF THE INVENTION

The primary object of the present invention is to provide a method for manufacturing microstructure using light hardenable material. It utilizes the light (such as UV light) hardenable material to form a solid and precise microstructure that has a plurality of at least micro-sized holes, recesses or special profiles.

Another object of the present invention is to provide a method for manufacturing microstructure using light hardenable material. It utilizes the sputtering principle to obtain a quickly and evenly distributed sputtered liquid light hardenable material. It significantly enhances the precision of the microstructure of the present invention.

Still another object of the present invention is to provide a method for manufacturing microstructure using light hardenable material. It saves the steps and time for mold modifying or calibration.

In order to achieve these objects, it is to provide the present invention that comprises the steps of:

(a) preparing step: providing a base having a plurality of protruded portions;

(b) sputtering step: sputtering a light hardenable material on said protruded portions evenly to form a light hardenable layer on said base;

(c) UV light exposing step: irradiating a ultraviolet (UV) light beam to said liquid light hardenable layer so that said light hardenable layer becomes a solid microstructure; and

(d) mold removing step: removing said solid microstructure so as to form a plurality of small holes; thereby forming a microstructure by using non-cooling light hardenable material.

### BRIEF DESCRIPTION OF THE DRAWINGS

FIG. 1 is a perspective view of a traditional plastic ink jet thin plate;

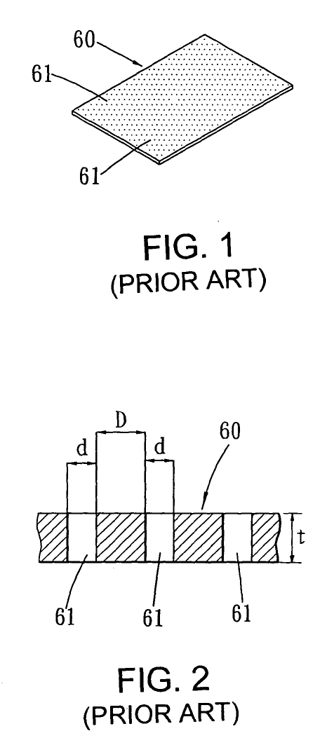

FIG. 2 is an enlarged cross-sectional view of a selected portion of the traditional plastic ink jet thin plate;

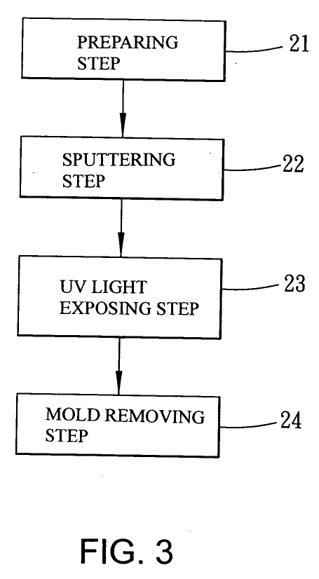

FIG. 3 is a flow chart of the present invention;

FIGS. 4A, 4B, 4C, 4D and 4E show the manufacturing process of the microstructure of the present invention at different stages; and

FIG. 5 illustrates another preferred embodiment of the microstructure of the present invention.

### DETAILED DESCRIPTION OF PREFERRED EMBODIMENTS

The present invention relates to a method for manufacturing microstructure using light hardenable material. Particularly, it is a method for manufacturing a micro-sized or nano-sized thin microstructure. One of its major applications is to improve the precision and resolution level of an ink jet printer.

In this embodiment of the present invention, the thin microstructure having a length of 7 mm, a width of 4 mm and a thickness of 50 micrometer (μm). In which, this microstructure has a plurality of small holes 161 (through holes).

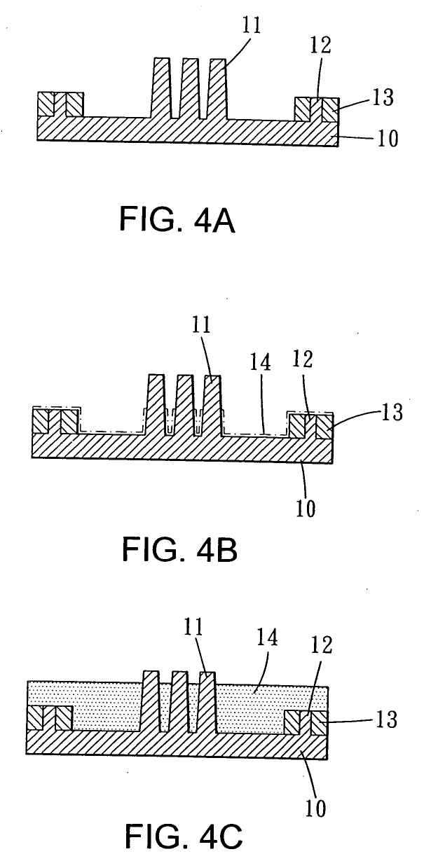

As shown in FIG. 3, the present invention is a method for manufacturing microstructure using light hardenable material. It comprises the steps of:

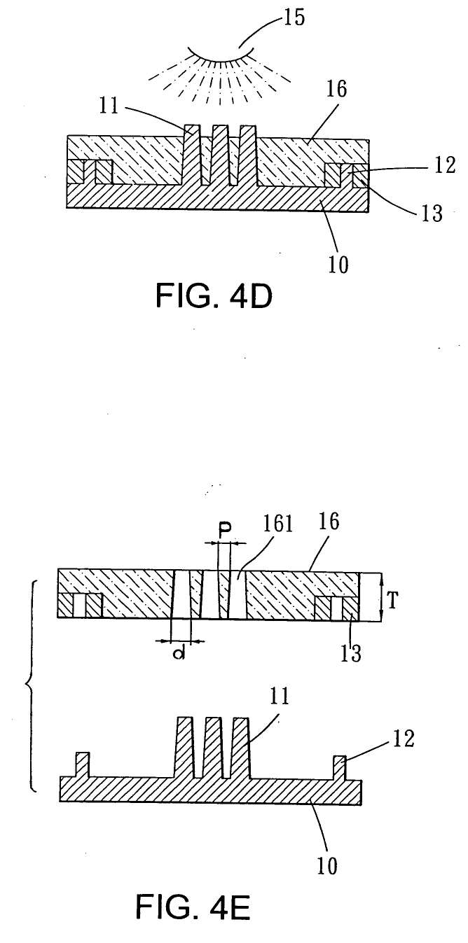

(a) preparing step 21: referring to FIG. 4A, providing a base 10 having a plurality of protruded portions 11 (only showing three for representing thousands of or more). The protruded portion 11 can have a conical periphery or a curved periphery, depending the product to be made. Of course, it preferably includes a procedure for sputtering a thin film of mold-removing agent (not shown) on the outer surface of the base 10. The base 10 has two lateral sides and at least two fitting protrusions 12 that are disposed on two lateral sides of the base 10 for fitting with a plurality of fitting blocks 13.

(b) sputtering step 22: referring to FIGS. 4B and 4C, sputtering a light hardenable material 14 (it preferably is a ultraviolet (UV) light hardenable resin, adhesive or liquid) on the protruded portions 10 and the fitting blocks 13 evenly to form a light hardenable layer on the base 10. The layer thickness of the light hardenable material 14 is gradually increased (see FIG. 4B) and finally forms a evenly distributed light hardenable layer on the base 10 having a predetermined thickness (see FIG. 4C).

(c) UV light exposing step 23: referring to FIGS. 4C and 4D, irradiating a ultraviolet (UV) light beam or the like (such as visible light or other type of light) to the liquid or viscous light hardenable material 14, so that said light hardenable material 14 becomes a solid microstructure (a thin plate). Furthermore, the solid light hardenable material 14 and fitting blocks 13 are fixed together as an integral solid microstructure plate 16.

(d) removing step: referring FIG. 4E, removing the solid microstructure plate 16 so as to form a plurality of small holes 161 (all through holes in FIG. 4E). In this embodiment, each of the small holes 161 is a through hole allowing a fluid (such as ink) to flow through.

The advantages and functions of this invention can be summarized as follows:

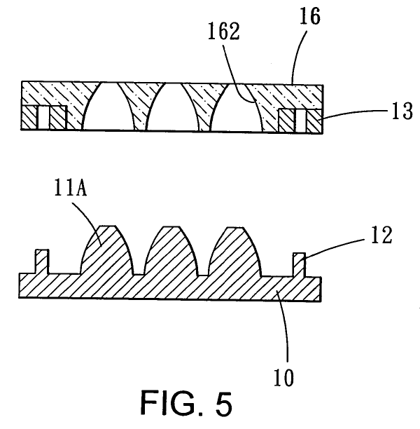

The microstructure of this invention is manufactured by solidifying the UV light hardenable material that is irradiated by a UV light source. It is totally different to the cooling method of the traditional plastic injection mold. Therefore, within a relatively short time, the UV light hardenable material is solidified. Comparing with the traditional cooling one, there is no expanding or shrinking effect due to temperature change. So, the precision control of the product of this invention is satisfactory. In addition, the profile of the small hole is not limited to a straight-lined surface profile. It is possible to be conical, curved or other special shapes. Except the conical example (shown in FIG. 4E), the curved hole 162 can be formed by a corresponding curved protruded portions 11A (shown in FIG. 5). By changing the profile of the small hole 161 or curved hole 162, the injected ink will be stronger (accelerating it flowing velocity) or more concentrated (having higher resolution and the injected ink dot is finer). Thus, this invention can produce a microstructure having special through holes or recesses for guiding fluid or other purpose.

By utilizing the sputtering technique, the liquid light hardenable material can be quickly and evenly distributed on the outer surface of the base. So, in this invention, the thickness and location of the sputtered light hardenable material can be precisely controlled.

By using this invention, the diameter (d) of the small hole is 100 μm, and the hold pitch (p) is between 100 to 200 μm. Therefore, comparing with the traditional one, the microstructure of this invention is a very precise product. Especially for the ink jet printer manufacturer, this invention significantly increases the resolution level of ink jet printer. As mentioned earlier, about the final product of this invention, the diameter (d) of the small hole is only 100 μm, the thickness (T) is only 50 μm, and the hole pitch (p) is only 100 to 200 μm.

The base can be integrally formed, so that it can save the steps and time for mold modifying or calibration.

Of course, this invention not only can manufacture the microstructure plate used on the ink jet printer, but also can apply to the microlens array, microlens, biotechnological chips or testing devices, tiny holes (or recesses) of a battery, or any microstructure having micro-sized holes (or recesses) in the nano-technology industry.

The above embodiments are only used to illustrate the present invention, not intended to limit the scope thereof. Many modifications of the above embodiments can be made without departing from the spirit of the present invention.

What is claimed is:

1. A method for manufacturing microstructure using light hardenable material, comprising the steps of:
(a) preparing step: providing a base having a plurality of protruded portions;
(b) sputtering step: sputtering a light hardenable material on said protruded portions evenly to form a light hardenable layer on said base;
(c) UV light exposing step: irradiating a ultraviolet (UV) light beam to said liquid light hardenable layer so that said light hardenable layer becomes a solid microstructure; and
(d) mold removing step: removing said solid microstructure so as to form a plurality of small holes; thereby forming a microstructure by using non-cooling light hardenable material.

2. A method for manufacturing microstructure using light hardenable material as claimed in claim 1, wherein one end of said small hole is a closed end.

3. A method for manufacturing microstructure using light hardenable material as claimed in claim 1, wherein each of said protruded portion has a conical periphery.

4. A method for manufacturing microstructure using light hardenable material as claimed in claim 1, wherein each of said protruded portion has a curved periphery.

5. A method for manufacturing microstructure using light hardenable material as claimed in claim 1, wherein in the preparing step, further includes a procedure for sputtering a thin film of mold-removing agent on an outer surface of said base.

6. A method for manufacturing microstructure using light hardenable material as claimed in claim 1, wherein said base has two lateral sides and a plurality of fitting protrusions disposed on said lateral sides of the base for fitting with a plurality of fitting blocks.

7. A method for manufacturing microstructure using light hardenable material as claimed in claim 1, wherein said light hardenable material is a UV light hardenable resin.

8. A method for manufacturing microstructure using light hardenable material as claimed in claim 1, wherein each said small hole is a through hole allowing an ink to flow through.
